(19) United States
(12) Patent Application Publication
(10) Pub. No.: US 2010/0015953 A1
(43) Pub. Date: Jan. 21, 2010

(54) Method and System for Transmitting an Instantaneous Message to a Terminal

(75) Inventors: Philippe Lucas, Bievres (FR); Diego Anza, Madrid (ES); Cécile Appert, Gentilly (FR)

Correspondence Address: COHEN, PONTANI, LIEBERMAN & PAVANE LLP, 551 FIFTH AVENUE, SUITE 1210, NEW YORK, NY, 10176, US

(73) Assignee: Orange France

(21) Appl. No.: 12/294,354

(22) PCT Filed: Mar. 23, 2007
(86) PCT No.: PCT/FR07/50992

§ 371 Date: Sep. 25, 2009

(30) Foreign Application Priority Data
Mar. 24, 2006 (FR) 0602613

(51) Int. Cl. H04L 12/58; H04W 4/00

(52) U.S. Cl. 455/412.1; 455/466

(57) ABSTRACT

A system for sending an instant message to a terminal that is not compatible with the instant messaging (IM) service. The system comprises a first terminal (10, 10′, 10″) that is compatible with said IM service, a second terminal (20, 20′, 20″) that is not compatible with said IM service and is compatible with a short message, an IM server (100) having means for managing said instant messaging service for said second terminal (20, 20′, 20″), and a short message center (200) including means for managing short messages coming from said IM server (100).

The present invention relates to a method and a system for sending a message from an instant messaging (IM) service to a terminal that is not compatible with said IM service.

The invention finds a particularly advantageous application in the field of sending an instant message to a terminal that does not include or is not compatible with an IM service enabling it to receive the message sent.

Prior art IM services send a message to a terminal almost in real time. The terminal includes a dedicated software application for receiving a message for “chatting” with the sender of the message. A number of senders can send (or receive) messages during an IM session.

Proprietary IM services specific to a particular provider include Yahoo Messenger and Google Talk. These services can send instant messages only to a terminal that is compatible with the proprietary IM service. These terminals include a software application specific to the IM service provider. Consequently, there is no interworking between instant messages sent by one messaging service and that of another provider.

There are also IM services that use standardized protocols. In particular, the Open Mobile Alliance (OMA) standardization forum has standardized the Instant Messaging and Presence Services (IMPS) protocol and the Internet Engineering Task Force (IETF) has standardized the extensible Messaging and Presence Protocol (XMPP) and the Session Initiation Protocol /SIP for Instant Messaging and Presence Leveraging Extensions) (SIP/SIMPLE). These services provide compatible transmission of instant messages between the various interoperable systems.

However, all these IM services require the installation in a terminal of a software application that enables the IM service to function (for example a Java applet). A terminal that does not include a software application specific to an IM service can neither receive nor send an instant message.

Thus a technical problem to be solved by the subject matter of the present invention is that of proposing a method of sending at least an instant message from at least an IM service to at least a terminal that would remove the drawbacks of existing methods and could send an instant message to a terminal that is not compatible with the IM service for chatting with a terminal that is compatible with said IM service almost in real time.

The solution according to the present invention to the technical problem is that said method comprises the steps of:
at least an IM server receiving said instant message from at least a first terminal that is compatible with said IM service to at least a second terminal that is not compatible with said IM service and is compatible with a short message;
said IM server assigning at least a short number to said first terminal and writing said short number as the number of the sender of said instant message;
converting said instant message into at least a short message to a telephone number of said second terminal; and
said IM server sending said short message to at least a short message center for forwarding to said second terminal.

The invention also relates to a system for sending at least an instant message from at least an IM service to at least a terminal that is not compatible with said IM service, which system comprises at least a first terminal that is compatible with said IM service, at least a second terminal that is not compatible with said IM service and is compatible with a short message, at least an IM server including means for managing said instant messaging service for said second terminal, and at least a short message center including means for managing short messages coming from said IM server.

In one embodiment of the invention, said IM server converts an IM protocol into a short message protocol and vice-versa.

Thus the system and the method of the invention send an instant message to a second terminal that is not compatible with an IM service and is compatible with a short message received and/or sent. The IM server effects conversion between an IM protocol and a short message protocol to send said instant message in the form of a short message to a short message center, which forwards it to said second destination terminal. Such conversion therefore provides instant message—short message continuity.

In one embodiment of the invention, said IM server automatically creates a user account for said second terminal after checking if such a user account exists.

When the IM server receives an instant message for a second terminal that does not subscribe to the IM service, it creates a user account, if no such account exists, to manage the subscriber who is not compatible with the IM service.

Moreover, according to the invention, said user account of said second terminal is permanently written to a “present” state.

In one embodiment of the invention, said present state is specific to said second terminal that is not compatible with said IM service.

In one embodiment of the invention, said specific present state is written to said second terminal without checking it.

In one particular embodiment of the invention, said specific present state is managed by said first terminal.

An important aspect of the invention is that, as the second terminal is not compatible with the IM service, a permanent present state is created by the IM server, according to the invention, to manage that subscriber as another instant messaging subscriber. This specific present state is managed in a particular way, both by the IM server and by said first terminal. Without this specific present state, the IM server cannot tell the difference between a subscriber who is not compatible with the IM service and a subscriber who is compatible with the IM service but is not logged on.

In another embodiment of the invention, said short number of said first terminal is specific to said IM server and identified by said short message center.

Clearly, in this way, the invention provides for particular and readily identifiable management by the IM server and the short message center. The short number assigned enables conversion of an instant message into a short message, with said short number as the number of the sender. The short message center, which receives a short message from the IM server, recognizes said short message as specific to instant message—short message continuity.

In one particular embodiment of the invention, said second terminal sends a short message to said short number of said first terminal, said short message center receiving and identifying said short message and said IM server receiving and converting it into an instant message.

An advantageous feature of the method of the invention is that it further includes a step of responding to the second terminal that is not compatible with the IM service but is compatible with a short message. The specific short number is identified by the short message center to forward said short message to an IM server. This converts the short message protocol into an IM protocol to send a response instant message to the addressee, who is compatible with the IM service. This conversion provides for short message—instant message continuity.

The following description with reference to the appended drawing, which is provided by way of non-limiting example, explains clearly in what the invention consists and how it can be reduced to practice.

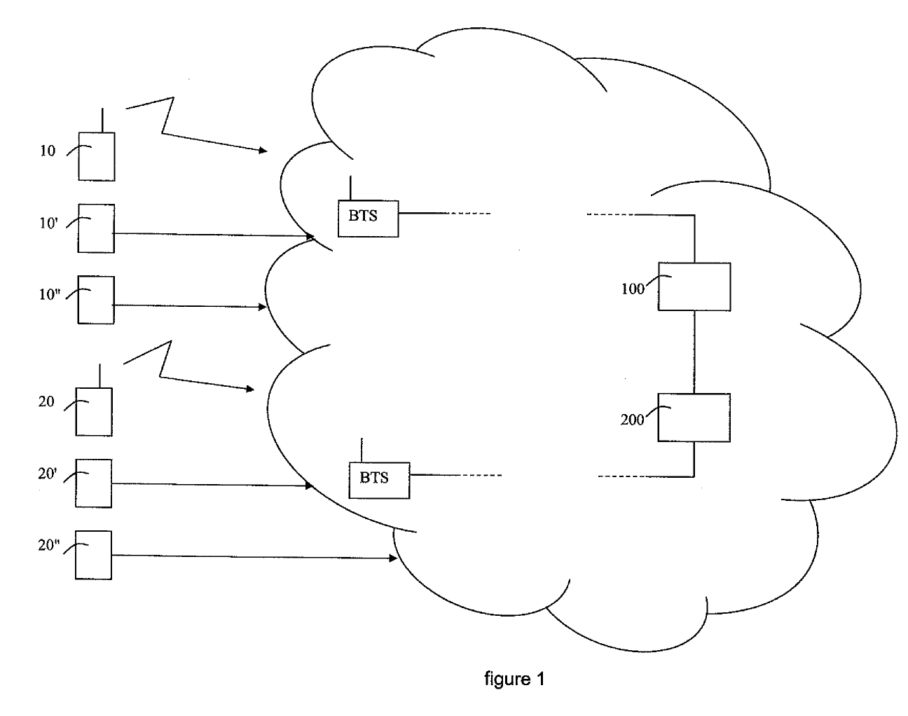

FIG. 1 represents the general architecture of a system of the invention for sending an instant message to a terminal that is not compatible with an IM service.

In the system of the invention, at least a first terminal 10, 10′, 10″ includes a software application specific to an IM service. In particular, said software application is installed in said first terminal 10, 10′, 10″ by downloading it from at least an IM server 100 corresponding to the IM service to which the user subscribes, or can instead be installed during manufacture of the terminal.

At least a second terminal 20, 20′, 20″ is not compatible with the IM service and in particular has no software application specific to any IM service. Said second terminal is compatible with receiving and/or sending a short message.

Said first and second terminals are connected to a fixed or mobile telecommunications network and are of any fixed or mobile kind, for example a mobile terminal or a personal computer (PC). This is in addition to their compatibility with at least an IM service (first terminal 10, 10′, 10″) and with receiving and/or sending a short message (second terminal 20, 20′, 20″).

Said IM server 100 of the invention, in addition to its usual functions, includes means for managing instant messaging for a terminal that is not compatible with the IM service. After first checking whether a user account exists or not, it automatically creates an IM user account for a second terminal 20, 20′, 20″ that is not compatible with the IM service. It assigns at least a short number to a first terminal 10, 10′, 10″ that is compatible with the IM service in order to be able to forward a short message to it from said second terminal 20, 20′, 20″. It converts instant messages coming from said first terminal 10, 10′, 10″ into short messages going to said second terminal 20, 20′, 20″, and vice-versa. It dialogues with a short message center 200 to send said short messages.

In addition to its usual functions, said short message center 200 of the invention includes means for managing short messages coming from an IM server 100. It identifies and stores a short number of the sender of a short message coming from an IM server 100 to enable forwarding of short messages to IM subscribers from said second terminal 20, 20′, 20″ that is not compatible with the IM service.

The user of the first terminal 10, 10′, 10″ creates a contact with whom they wish to chat via the IM service. To this end, the user stores an IM identifier of the contact. That IM identifier can be in alphanumeric form (the name and/or forename of the person or a nickname) or the telephone number of the contact. The telephone number of the contact can be selected in the address book of the first terminal 10, 10′, 10″, for example.

The new contact created is then added to a list of IM contacts for instant messaging.

The IM identifier of the contact that has been created is sent to said IM server 100. Said telephone number of the second terminal 20, 20′, 20″ is sent by said first terminal 10, 10′, 10″ as an identifier for use by the IM server 100.

Following its reception, the server 100 verifies if the IM identifier sent belongs to a list of IM service subscribers by comparison with the content of an existing subscriber database including the telephone number.

If said contact also has a terminal equipped with a software application specific to an IM service, they are listed in a list of IM contacts of the first terminal 10, 10′, 10″ as a terminal compatible with the IM service.

As provided for by IM services, said contact compatible with the IM service authorizes (or not) transmission of their presence state. The server 100 therefore sends the first terminal 10, 10′, 10″ the presence state of the new contact compatible with the IM service, to set up an IM dialogue almost in real time knowing that said terminal is present (or not).

However, the contact may have a second terminal 20, 20′, 20″ that is not compatible with the IM service. Specifically, the second terminal 20, 20′, 20″ includes no software application specific to an IM service. In particular, the second terminal 20, 20′, 20″ is not equipped to send instant messages or is not compatible with the message received. Said second terminal 20, 20′, 20″ is compatible with a short message received and/or sent.

The IM server 100 of the invention then creates automatically an IM user account for said second terminal 20, 20′, 20″, if the IM identifier transmitted does not correspond to an existing account, after checking whether an account exists (or not). According to the parameters of the system, for example, said IM user account can be created on the basis of the telephone number sent or on the basis of the name and/or the forename and/or the nickname of the contact, or by generating an IM user account name at random.

Moreover, because the second terminal 20, 20′, 20″ is not compatible with the IM service, the server 100 cannot detect its presence (or absence), said second terminal 20, 20′, 20″ not sending that information. Consequently, said IM user account is permanently in a specific “present” state for said second terminal 20, 20′, 20″ not compatible with the IM service.

This specific “present” state distinguishes a subscriber who is not compatible with the IM service from a subscriber who is compatible with the IM service but is not logged on. This specific “present” state is a “false” presence state, as said second terminal 20, 20′, 20′ does not transmit any presence information.

Because of this, regardless of the IM session set up by all the first terminals 10, 10′, 10″ of the system, the server 100 automatically validates a presence request corresponding to all the second terminals 20, 20′, 20″ that are not compatible with the IM service. Said second terminals 20, 20′, 20″ cannot manage a presence request coming from a terminal 10, 10′, 10″ compatible with the IM service.

Said specific “present” state can be sent to said second terminal 20, 20′, 20″ not compatible with the IM service without authorization by the subscriber, and without any checking, as this state is permanent.

Said system can detect the “logged onto the network” state (or not) for said second terminal 20, 20′, 20″ from equipments of the telecommunications network provided for this purpose.

The server 100 sends the first terminal 10, 10′, 10″ a message to identify said second terminal 20, 20′, 20″ as incompatible with the IM service and with a permanent “present” state specific to said second terminal 20, 20′, 20″.

The second terminal 20, 20′, 20″ is then entered into a list of IM contacts of the first terminal 10, 10′, 10″ in a particular way, as a terminal that is not compatible with the IM service. Said specific “present” state is managed by said first terminal 10, 10′, 10″. For example, this contact can be displayed in a different color in a list of IM contacts or be marked with a particular character, logo or text, etc.

The first terminal 10, 10′, 10″ sets up an IM session without changing how the IM service functions. It sends an instant message to said IM server 100. The server 100 forwards said instant message to all terminals compatible with the IM service using an existing IM protocol.

The server 100 receives said instant message from a first terminal that is compatible with said IM service to be sent to a second terminal that is not compatible with said IM service and is compatible with a short message received and/or sent.

The server 100 stores the incompatibility of the second terminal 20, 20′, 20″ with the IM service. The server 100 converts the IM protocol instant message into at least a message that can be processed by a short message center 200. This conversion therefore provides instant message—short message continuity.

In particular, the short message center 200 can be a short message service center (SMSC) for sending a text message (SMS message) or a multimedia service center (MMSC) for sending a multimedia message (MMS message) also comprising a text, a photo, a video, etc., or any other short message center configured to send a message without using instant messaging.

For example, an IM server 100 effects conversion between IM (instant messaging) and SMS (short message service) to enable communication between said first terminal 10, 10′, 10″ and said second terminal 20, 20′, 20″.

The server 100 stores all first terminals 10, 10′, 10″ that have set up an IM session with said second terminal 20, 20′, 20″. The server 100 then assigns a different short number to each of said first terminals 10, 10′, 10″ so as to be able to forward a short message coming from and going to said first terminals 10, 10′, 10″. Said short numbers are specific to converting an IM instant message into a short message, such as an SMS or MMS message, and for converting a short message into an instant message. This conversion therefore provides instant message—short message continuity.

Said short number of said first terminal 10, 10′, 10″ is specific to the IM server 100 and identified by at least a short message center 200.

The IM server 100 converts said instant message into at least a short message. The IM server 100 is configured to perform protocol conversion between one or more IM protocols and one or more short message protocols (SMS, MMS, etc.).

Because of the conversion effected by the IM server 100, said short number assigned to a first terminal 10, 10′, 10″ is written as the number of the sender for an instant message sent by said first terminal 10, 10′, 10″ to a second terminal 20, 20′, 20″. The destination number is said telephone number of the second terminal 20, 20′, 20″ stored by the IM server 100. The content of the short message is the content of said instant message, text and/or photo and/or video, etc. The IM server 100 processes said instant message for conversion into a short message. The IM server 100 can process the instant message for improved comprehension by the receiver of the short message. In particular, the server 100 can add the name of the sender to the beginning of the instant message, for example “xxx says: . . . ”.

The server 100 has assigned a short number to said first terminal and writes said short number as the number of the sender of the instant message. It has converted said instant message into a short message to be sent to a telephone number of said second terminal 20, 20′, 20″.

Said IM server 100 is configured, in addition to its usual functions, to send said short message automatically to said short message center 200.

The IM server 100 sends to said short message center 200 a request that contains at least the content of the instant message. The server 100 has sent said short message to a short message center 200 for forwarding to said second terminal 20, 20′, 20″, which is compatible with a short message received and/or sent.

Said short message center 200 identifies and stores the short number of the sender as a short number specific to an IM server 100. Said short message center 200 is configured, in addition to its usual functions, to identify said specific short number for an IM server 100 automatically. It transmits a short message (for example a SMS message) containing at least the content of said instant message to the destination second terminal 20, 20′, 20″.

The user of said destination second terminal 20, 20′, 20″ receives said short message with an indication of the sender and can store, for example in the phone book of the terminal, the short number of the sender corresponding to said first terminal 10, 10′, 10″ for communicating by means of instant messages (for example “xxx IM”).

If the second terminal 20, 20′, 20″ responds, it sends a new short message to the received short number, for example “xxx IM”. Said short message is transmitted to the short message center 200. Said short message center 200 is configured to identify a short number specific to an IM server 100 automatically. The short message center 200 is configured, in addition to its usual functions, to send said short message identified by said specific short number to said IM server 100 automatically.

The second terminal 20, 20′, 20″ has sent a short message to said short number of said first terminal 10, 10′, 10″, said short message being received and identified by the short message center 200, then received and converted into an instant message by said IM server 100.

The server 100 receives a short message from the telephone number of said second terminal 20, 20′, 201 to an IM-specific short number. The server 100 searches a database for a match with a first terminal 10, 10′, 10″ compatible with the IM service. The IM server 100 is configured, in addition to its usual functions, to send said short message automatically to a first terminal 10, 10′, 10″.

Following this search, it sends said short message to said first terminal 10, 10′, 10″ after IM protocol conversion. The IM server 100 is configured to effect protocol conversion between a short message protocol and an IM protocol. This conversion provides short message—instant message continuity.

The first terminal 10, 10′, 10″ receives an instant message in a form identical to that received from a terminal compatible with the IM service. The IM session between different first and second terminals 10, 10′, 10″ and 20, 20′, 20″, whether compatible with the IM service or not, can continue for dialogue almost in real time.

There are also provided a computer program, comprising code portions for executing the steps of the method as defined above, and a computer-readable storage medium storing said computer program.

1. A method of sending an instant message to a terminal that is not compatible with the instant messaging (IM) service, wherein said method comprises the steps of:
an IM server (100) receiving said instant message from a first terminal (10, 10′, 10″) that is compatible with said IM service to a second terminal (20, 20′, 20″) that is not compatible with said IM service and is compatible with a short message;
said IM server (100) assigning a short number to said first terminal (10, 10′, 10″) and writing said short number as the number of the sender of said instant message;
converting said instant message into a short message to a telephone number of said second terminal (20, 20′, 20″); and
said IM server (100) sending said short message to a short message center (200) for forwarding to said second terminal (20, 20′, 20″).

2. The method according to claim 1, wherein said IM server (100) automatically creates a user account for said second terminal (20, 20′, 20″) after checking if such a user account exists.

3. The method according to claim 2, wherein said user account of said second terminal (20, 20′, 20″) is permanently written to a “present” state.

4. The method according to claim 3, wherein said present state is specific to said second terminal (20, 20′, 20″) that is not compatible with said IM service.

5. The method according to claim 3, wherein said specific present state is written to said second terminal (20, 20′, 20″) without checking it.

6. The method according to claim 1, wherein said specific present state is managed by said first terminal (10, 10′, 10″).

7. The method according to claim 1, wherein said short number of said first terminal (10, 10′, 10″) is specific to said IM server (100) and identified by said short message center (200).

8. The method according to claim 1, wherein said IM server (100) converts an IM protocol into a short message protocol and vice-versa.

9. The method according to claim 1, wherein said IM server (100) processes said instant message for conversion into a short message.

10. The method according to claim 1, wherein said first terminal (10, 10′, 10″) sends said telephone number of said second terminal (20, 20′, 20″) as an identifier for said IM server (100).

11. The method according to claim 1, wherein said second terminal (20, 20′, 20″) sends a short message to said short number of said first terminal (10, 10′, 10″), said short message center (200) receiving and identifying said short message and said IM server (100) receiving and converting it to an instant message.

12. A computer program comprising code portions for executing the steps of the method according to claim 1.

13. A computer-readable storage medium storing said computer program according to claim 12.

14. A system for sending an instant message to a terminal that is not compatible with the instant messaging (IM) service, wherein said system comprises a first terminal (10, 10′, 10″) that is compatible with said IM service, a second terminal (20, 20′, 20″) that is not compatible with said IM service and is compatible with a short message, an IM server (100) including means for managing said instant messaging service for said second terminal (20, 20′, 20″), and a short message center (200) including means for managing short messages coming from said IM server (100).

15. A terminal (10, 10′, 10″) compatible with an instant messaging (IM) service, wherein said terminal comprises:
means for implementing the method according to claim 1; and
a system for sending the instant message to a terminal that is not compatible with the instant messaging (IM) service, wherein said system comprises
a first terminal (10, 10′, 10″) that is compatible with said IM service,
a second terminal (20, 20′, 20″) that is not compatible with said IM service and is compatible with a short message,
an IM server (100) including means for managing said instant messaging service for said second terminal (20, 20′, 20″), and
a short message center (200) including means for managing short messages coming from said IM server (100).

16. A terminal (10, 10′, 10″) according to claim 15, wherein said terminal has means for managing a specific present state for a second terminal (20, 20′, 20″) that is not compatible with said IM service.

17. A terminal (20, 20′, 20″) that is not compatible with an instant messaging (IM) service and is compatible with a short message, wherein said terminal comprises:
means for implementing the method according to claim 1; and
a system for sending the instant message to a terminal that is not compatible with the instant messaging (IM) service, wherein said system comprises
a first terminal (10, 10′, 10″) that is compatible with said IM service,
a second terminal (20, 20′, 20″) that is not compatible with said IM service and is compatible with a short message,
an IM server (100) including means for managing said instant messaging service for said second terminal (20, 20′, 20″), and
a short message center (200) including means for managing short messages coming from said IM server (100).

18. An instant messaging (IM) server (100) for implementing the method according to claim 1; and
a system for sending the instant message to a terminal that is not compatible with the instant messaging (IM) service, wherein said system comprises
a first terminal (10, 10′, 10″) that is compatible with said IM service,
a second terminal (20, 20′, 20″) that is not compatible with said IM service and is compatible with a short message,
an IM server (100) including means for managing said instant messaging service for said second terminal (20, 20′, 20″), and
a short message center (200) including means for managing short messages coming from said IM server (100),
wherein the instant messaging server further comprises means for assigning a specific short number to a first terminal (10, 10′, 10″) compatible with said IM service.

19. An IM server (100) according to claim 18, comprising means for sending a short message to a short message center (200) automatically.

20. A short message center (200) for implementing the method according to claim 1; and
a system for sending the instant message to a terminal that is not compatible with the instant messaging (IM) service, wherein said system comprises
a first terminal (10, 10′, 10″) that is compatible with said IM service,
a second terminal (20, 20′, 20″) that is not compatible with said IM service and is compatible with a short message,
an IM server (100) including means for managing said instant messaging service for said second terminal (20, 20′, 20″), and
a short message center (200) including means for managing short messages coming from said IM server (100),
wherein the short message center further comprises means for automatically identifying a short number specific to an instant messaging (IM) server (100).

21. A short message center (200) according to claim 20, comprising means for automatically sending said IM server (100) a short message identified by said specific short number.
